(19) United States
(12) Patent Application Publication
(10) Pub. No.: US 2025/0058996 A1
(43) Pub. Date: Feb. 20, 2025

(54) SYSTEMS AND METHODS FOR PARKING ELEVATORS

(71) Applicant: Appana Industries LLC, Jamaica, NY (US)

(72) Inventor: Amarnauth APPANA, JR., Jamaica, NY (US)

(73) Assignee: Appana Industries LLC, Jamaica, NY (US)

(21) Appl. No.: 18/936,391

(22) Filed: Nov. 4, 2024

Related U.S. Application Data
(63) Continuation of application No. 17/443,431, filed on Jul. 26, 2021.
(60) Provisional application No. 63/058,261, filed on Jul. 29, 2020.

(51) Int. Cl. B66B 1/24; B66B 5/00

(52) U.S. Cl. CPC B66B 1/2408; B66B 5/0012; B66B 2201/242; B66B 2201/403

(57) ABSTRACT

A method for positioning a plurality of elevator cars that includes determining an occupant count for each of a plurality of locations, by determining the number of occupants exiting the plurality of elevator cars at each of the plurality of locations and the number of occupants entering the plurality of elevator cars from each of the plurality of locations. The method includes moving at least one of the plurality of elevator cars to a first location with a total occupant count that is greater than the occupant count at each respective location of the plurality of locations when the at least one of the plurality of elevator cars is in an inactive state.

### CROSS-REFERENCE TO RELATED APPLICATIONS

This application is a continuation of U.S. application Ser. No. 17/443,431, filed Jul. 26, 2021, which claims the benefit of priority from U.S. Provisional Application No. 63/058,261, filed on Jul. 29, 2020, which are incorporated by reference in their entireties.

### TECHNICAL FIELD

Aspects of the present disclosure relate generally to systems and methods for controlling elevator traffic flow, and specifically to examples of elevator control systems that position inactive (idle) elevator cars at one or more locations based on a relative occupant count at the locations.

### DESCRIPTION OF RELATED TECHNOLOGY

Elevator systems may generally maintain elevator cars at a location at which the elevator car was previously used when no further call requests for the elevator car exist. That is, the elevator car is parked at a location (e.g., a floor) to which it last traveled to when completing a prior trip. In such systems, the elevator car may remain in an idle state at said location until a subsequent call is received. However, maintaining inactive elevator cars at a location of last use may result in positioning elevator cars at a location having fewer occupants than other locations. As a result, an elevator car may be required to travel a greater distance to answer a call from a location (e.g., a floor) with a greater likelihood of providing a future call request, based on an occupant count at the location, thereby resulting in decreased traffic flow and greater wait times for prospective passengers. Providing a system capable of positioning inactive elevator cars at locations with greater occupants may minimize travel distances when answering a call, thereby increasing traffic flow and decreasing wait times for prospective passengers.

### BRIEF DESCRIPTION OF DRAWINGS

The accompanying drawings, which are incorporated in and constitute a part of this disclosure, illustrate various exemplary embodiments and together with the description, serve to explain the principles of the disclosure.

Aspects of the disclosure may be implemented in connection with embodiments illustrated in the attached drawings. These drawings show different aspects of the present disclosure and, where appropriate, reference numerals illustrating like structures, components, materials and/or elements in different figures are labeled similarly. It is understood that various combinations of the structures, components, and/or elements, other than those specifically shown, are contemplated and are within the scope of the present disclosure. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a dispatch system including one or more devices in communication over a network.

FIG. 2 is a schematic view of a working environment including multiple elevator cars interacting with the dispatch system shown in FIG. 1.

FIG. 3 is a top view of an interior of an elevator car from the working environment shown in FIG. 2.

FIG. 4 is a schematic view of hardware components of a computing device from the dispatch system shown in FIG. 1.

FIG. 5 is a flow diagram of an exemplary method of positioning elevator cars with the dispatch system shown in FIG. 1.

FIG. 6 is a flow diagram of an exemplary method of disregarding calls at an elevator car with the dispatch system shown in FIG. 1.

### SUMMARY

According to an example, a method for positioning a plurality of elevator cars includes determining an occupant count for each of a plurality of locations by determining the number of occupants exiting the plurality of elevator cars at each of the plurality of locations and determining the number of occupants entering the plurality of elevator cars from each of the plurality of locations. The method includes moving at least one of the plurality of elevator cars to a first location with a total occupant count that is greater than the occupant count at each respective location of the plurality of locations when the at least one of the plurality of elevator cars is in an inactive state.

According to another example, a system for positioning a plurality of elevator cars includes at least one counter device positioned in each of the plurality of elevator cars. The at least one counter device is configured to generate data indicative of a number of occupants in the plurality of elevator cars. The system includes a dispatch controller operably coupled to the at least one counter device in each of the plurality of elevator cars such that the dispatch controller receives data indicative of the number of occupants in the plurality of elevator cars. The dispatch controller is configured to determine an occupant count for each of a plurality of locations by determining the number of occupants exiting the plurality of elevator cars at each of the plurality of locations and determining the number of occupants entering the plurality of elevator cars from each of the plurality of locations. The dispatch controller is configured to move at least one of the plurality of elevator cars to a first location with a total occupant count that is greater than the occupant count at each respective location of the plurality of locations when the at least one of the plurality of elevator cars is in an inactive state.

According to a further example, a system for controlling traffic flow of a plurality of elevator cars includes a processor and a memory storing instructions that, when executed by the processor, causes the processor to perform operations including determining an occupant count for each of a plurality of locations by determining the number of occupants exiting the plurality of elevator cars at each of the plurality of locations and determining the number of occupants entering the plurality of elevator cars from each of the plurality of locations. The processor performs operations including moving at least one of the plurality of elevator cars to a first location with a total occupant count that is greater than the occupant count at each respective location of the plurality of locations when the at least one of the plurality of elevator cars is in an inactive state.

### DETAILED DESCRIPTION

The dispatch system of the present disclosure may be in the form of varying embodiments, some of which are depicted by the figures and further described below.

Both the foregoing general description and the following detailed description are exemplary and explanatory only and are not restrictive of the features, as claimed. As used herein, the terms “comprises,” “comprising,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/−10% (unless a different variation is specified) from the disclosed numeric value. Moreover, in the claims, values, limits, and/or ranges mean the value, limit, and/or range +/−10%.

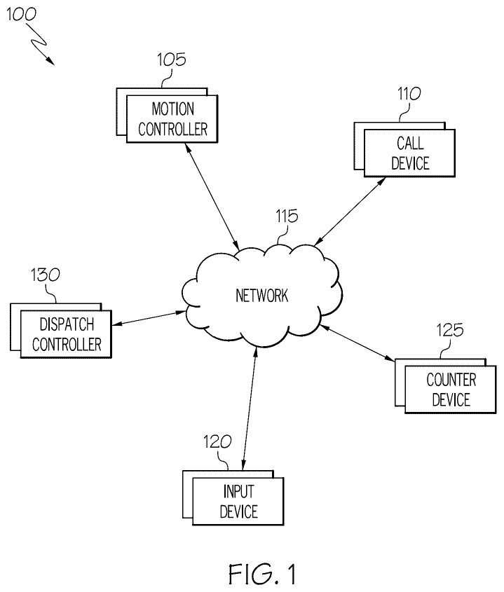

FIG. 1 shows an exemplary dispatch system 100 that may include motion controller 105, call device 110, input device 120, counter device 125, and dispatch controller 130. The one or more devices of dispatch system 100 may communicate with one another across a network 115 and in any arrangement. For example, the devices of dispatch system 100 may be communicatively coupled to one another via a wired connection, a wireless connection, or the like. In some embodiments, network 115 may be a wide area network (“WAN”), a local area network (“LAN”), personal area network (“PAN”), etc. Network 115 may further include the Internet such that information and/or data provided between the devices of dispatch system 100 may occur online (e.g., from a location remote from other devices or networks coupled to the Internet). In other embodiments, network 115 may utilize Bluetooth® technology and/or radio waves frequencies.

Motion controller 105 may be operably coupled to a transportation unit and configured to detect and transmit motion data of the transportation unit to one or more devices of dispatch system 100, such as, for example, dispatch controller 130. For example, motion controller 105 may measure and record one or more parameters (e.g., motion data) of the transportation unit, including, but not limited to, a current location, a travel direction, a travel speed, a door location, a status (e.g., active, inactive, moving, parked, idle, etc.), and more. Motion controller 105 may include a computing device having one or more hardware components (e.g., a processor, a memory, a sensor, a communications module, etc.) for generating, storing, and transmitting the motion data. As described in further detail herein, motion controller 105 may be operably coupled to an elevator car located within a building and dispatch system 100 may include at least one motion controller 105 for each elevator car.

Still referring to FIG. 1, call device 110 may be positioned outside the transportation unit and configured to receive a user input from one or more prospective occupants for accessing the transportation unit. For example, the user input may be indicative of a call requesting transportation from the transportation unit. Call device 100 may be configured to transmit the call request to one or more devices of dispatch system 100, such as, for example, dispatch controller 130. Call device 110 may include a keypad, a touchscreen display, a microphone, a button, a switch, etc. Call device 110 may be further configured to receive a user input indicative of a current location of the call request (e.g., a first location) and/or a destination location (e.g., a second location) from a plurality of locations.

As described in further detail herein, call device 110 may be located within a building and dispatch system 100 may include at least one call device 100 for each floor of the building. Call device 100 may be configured to transmit a message from one or more devices of dispatch system 100 (e.g., dispatch controller 130) identifying an elevator car assigned to arrive at the floor of the building to answer the call request. The message may be communicated by call device 100 via various suitable formats, including, for example, in a written form, an audible form, a graphic form, and more.

Input device 120 may be positioned inside the transportation unit and configured to receive a user input from one or more occupants of the transportation unit. For example, the user input may be indicative of a command requesting redirection of the transportation unit. Input device 120 may be configured to transmit the command to one or more devices of dispatch system 100, such as, for example, dispatch controller 130. Input device 120 may include a keypad, a touchscreen display, a microphone, a button, a switch, etc. As described in detail herein, input device 120 may be located within an elevator car and dispatch system 100 may include at least one input device 100 for each elevator car in a building. In other embodiments, input device 120 may be omitted entirely from dispatch system 100.

Still referring to FIG. 1, counter device 125 may be positioned inside the transportation unit and configured to detect and transmit occupant data of the transportation unit to one or more devices of dispatch system 100, such as, for example, dispatch controller 130. For example, counter device 125 may measure and record a number of objects located within the transportation unit, including, but not limited to, an occupant, a personal belonging, a luggage, a baggage, and more. Counter device 125 may include an optical system facing an interior of the transportation unit, such as, for example, a sensor, a camera, a light beam, an infrared detector, etc. As described in further detail herein, counter device 125 may be coupled to an elevator car that is located within a building and dispatch system 100 may include at least one counter device 125 for each elevator car of the building.

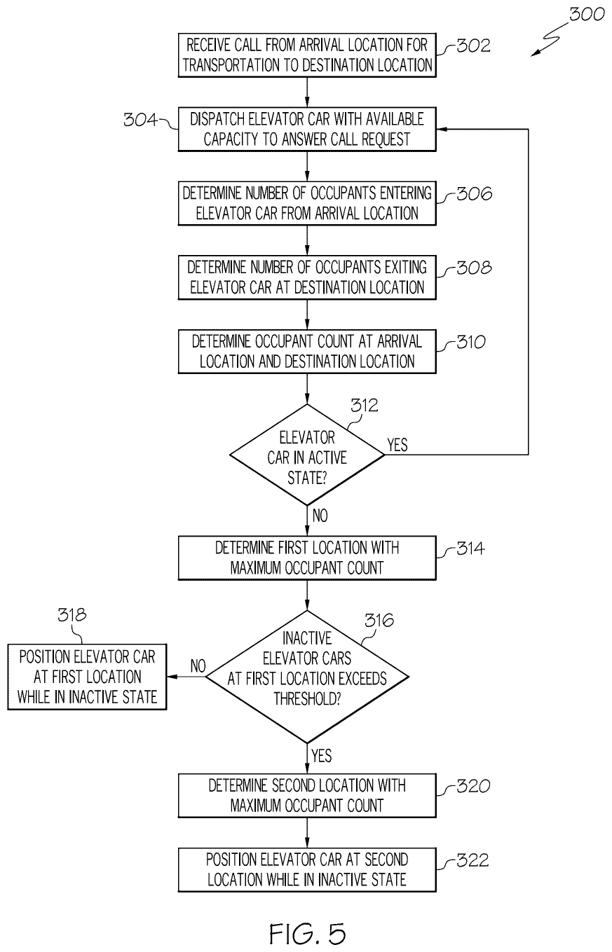

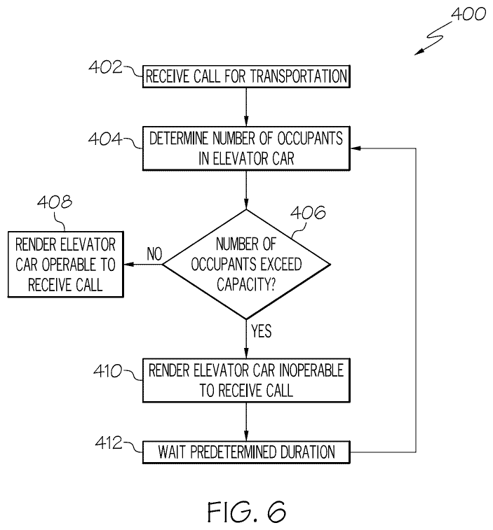

Dispatch controller 130 may be positioned outside the transportation unit and configured to receive data (e.g., motion data, a call request, a redirection command, occupant data, etc.) from one or more devices of dispatch system 100. Dispatch controller 130 may be configured to determine at least one transportation unit of a plurality of transportation units to dispatch to a location of a call request received from a prospective occupant seeking transportation. Dispatch controller 130 may be further configured to determine an occupant count for a plurality of locations (e.g., within a building) based on the data received from the one or more devices of dispatch system 100. Dispatch controller 130 may include a computing device (see FIG. 4) operable to perform one or more processes (see FIG. 5) for moving transportation units in an inactive state to a location with a total occupant count that is greater than an occupant count at a plurality of other locations. Dispatch controller 130 may be further operable to perform one or more processes (see FIG. 6) for rendering transportation units inoperable to receive a call request when a current occupant count of the transportation unit exceeds its occupant capacity. As described in further detail herein, dispatch controller 130 may be operably coupled to a plurality of elevator cars located within a building and dispatch system 100 may include at least one dispatch controller 130 for each building.

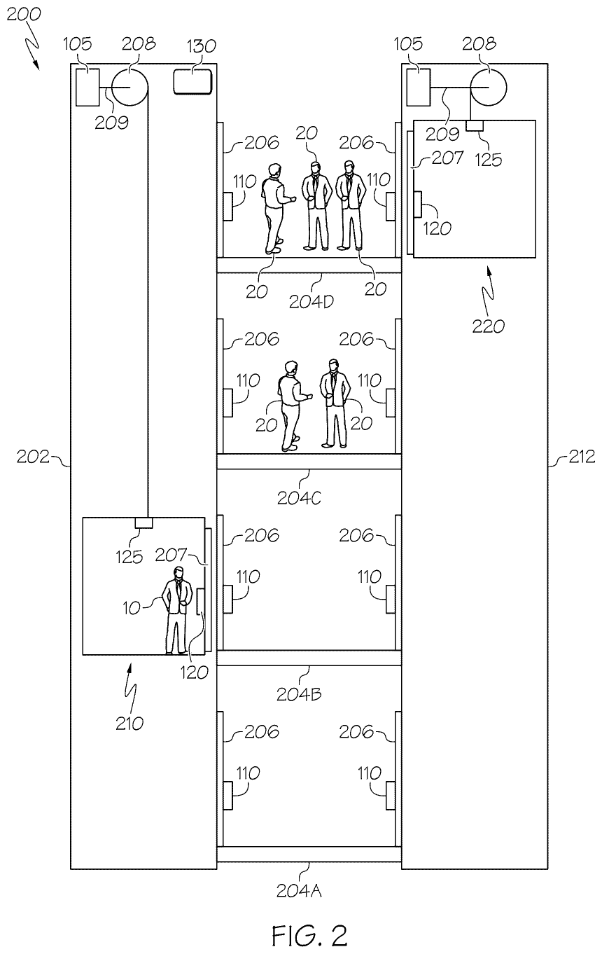

Referring now to FIG. 2, dispatch system 100 may be utilized in a working environment 200, such as a building (e.g., a facility, a factory, a store, a school, a house, an office, and various other structures). In the example, the transportation unit may include one or more elevator cars within the building. It should be appreciated that working environment 200 is merely illustrative such that dispatch system 100 may be utilized in various other suitable environments than those shown and described herein without departing from a scope of this disclosure. For example, the working environment may include a mass transit system such that the transportation unit(s) may include a bus, a train, a subway car, a metro car, a vehicle, etc. In the present example, working environment 200 may include a plurality of floors defining a plurality of locations within the building, such as first floor 204A, second floor 204B, third floor 204C, and fourth floor 204D. It should be appreciated that, in other embodiments, the building of working environment 200 may include additional and/or fewer floors.

Working environment 200 may further include one or more elevator shafts with at least one elevator car positioned within each elevator shaft. In the example, working environment 200 includes a first elevator shaft 202 with at a first elevator car 210 and a second elevator shaft 212 with a second elevator car 220. Although not shown, it should be appreciated that working environment 200 may include additional (e.g., a plurality) elevator shafts and/or elevator cars. Each elevator car 210, 220 may be coupled to a pulley system 208 configured to move elevator cars 210, 220 within elevator shafts 202, 212 and relative to floors 204A-204D. It should be understood that pulley system 208 may include various mechanical and/or electrical mechanisms for moving elevator cars 210, 220 within elevator shafts 202, 212, including but not limited to, a motor, a cable, a counterweight, a sheave, etc.

Still referring to FIG. 2, each elevator car 210, 220 may include at least one motion controller 105 operably coupled to pulley system 208, such as, for example, via a wireless connection and/or a wired connection 209. Motion controller 105 may be configured to measure motion data (e.g., a status) from elevator cars 210, 220 by detecting a relative movement of pulley system 208. Each elevator car 210, 220 may further include at least one input device 120 positioned within a cabin of elevator car 210, 220 for receiving a user input from one or more occupants 10 located within the cabin.

Each floor 204A-204D may include one or more call devices 110 and access doors 206 providing accessibility to elevator cars 210, 220 when an elevator door 207 of elevator car 210, 220 is aligned with the respective floor 204A-204D. Call device 110 may be configured to receive a user input from one or more prospective occupants 20 located at one of the plurality of floors 204A-204D. For example, call device 110 may be configured to receive a user input indicative of a call requesting transportation via at least one of elevator cars 210, 220. Call device 100 may be configured to transmit the call request to dispatch controller 130, which may include data indicative of a current location within working environment 200 from which the call request originated from. The call request may further include data indicative of a destination location within working environment 200 to which the prospective passenger is seeking transportation to.

Still referring to FIG. 2, each elevator car 210, 220 may further include at least one counter device 125 positioned within a cabin. Counter device 125 may be positioned along an inner wall (e.g., a ceiling) of each elevator car 210, 220 and configured to detect a number of occupants 10 within the cabin. In some embodiments, counter device 125 may be operable to distinguish between one or more objects detected within elevator cars 210, 220.

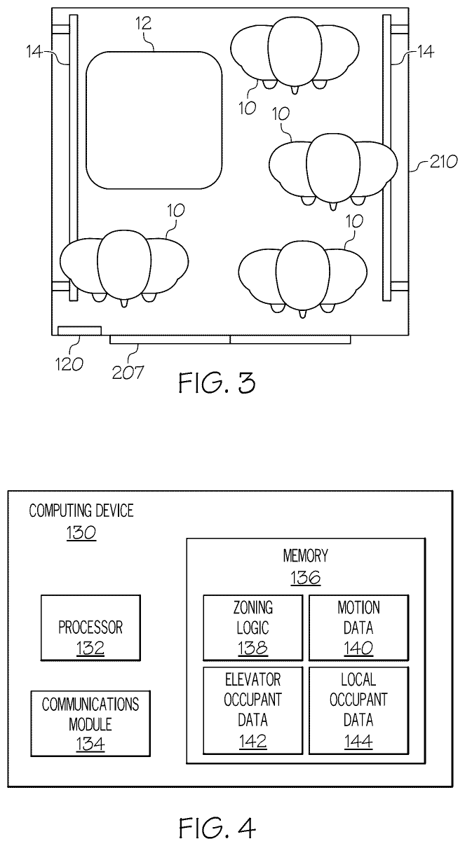

For example, as seen in FIG. 3, counter device 125 may be configured to detect items present within the cabin and occupying a capacity of elevator cars 210, 220 (e.g., occupants 10, ancillary objects 12, etc.) and items within the cabin that may not occupy a capacity of elevator cars 210, 220 (e.g., rails 14, etc.). Counter device 125 may measure a number of items detected within elevator cars 210, 220 and record such measurements as occupant data. As discussed further herein, counter device 125 may be configured to transmit the occupant data for each elevator car 210, 220 to dispatch controller 130 via network 115 for determining a number of occupants at a plurality of locations.

Referring now to FIG. 4, dispatch controller 130 may include a computing device incorporating a plurality of hardware components that allow dispatch controller 130 to receive data (e.g., motion data, call requests, commands, occupant data, etc.), process information (e.g., occupant capacity), and/or execute one or more processes (see FIGS. 5-6). Illustrative hardware components of dispatch controller 130 may include at least one processor 132, at least one communications module 134, and at least one memory 136. In some embodiments, dispatch controller 130 may include a computer, a mobile user device, a remote station, a server, a cloud storage, and the like. In the illustrated embodiment, dispatch controller 130 is shown and described herein as a separate device from the other devices of dispatch system 100, while in other embodiments, one or more aspects of dispatch controller 130 may be integrated with one or more of the other devices of dispatch system 100. Stated differently, the illustrative hardware components of dispatch controller 130 shown and described herein may be integral with one or more of motion controller 105, call device 110, input device 120, and/or counter device 125.

Processor 132 may include any computing device capable of executing machine-readable instructions, which may be stored on a non-transitory computer-readable medium, such as, for example, memory 136. By way of example, processor 132 may include a controller, an integrated circuit, a microchip, a computer, and/or any other computer processing unit operable to perform calculations and logic operations required to execute a program. As described in detail herein, processor 132 is configured to perform one or more operations in accordance with the instructions stored on memory 136, such as, for example, zoning logic 138.

Still referring to FIG. 4, memory 136 may include various programming algorithms and data that support an operation of dispatch system 100. Memory 136 may include any type of computer readable medium suitable for storing data and algorithms, such as, for example, random access memory (RAM), read only memory (ROM), a flash memory, a hard drive, and/or any device capable of storing machine-readable instructions. Memory 136 may include one or more data sets, including, but not limited to, motion data 140 received from motion controller 105, elevator occupant data 142 and/or local occupant data 144 captured from counter device 125 (collectively referred to as “occupant data”), and the like.

As described further herein, elevator occupant data 142 may include a real-time count of occupants 10 (and/or ancillary objects 12) detected within a cabin of each elevator car 210, 220 by counter device 125. Local occupant data 144 may include a number of occupants 10 previously detected within at least one elevator car 210, 220, by counter device 125, and transported to at least one of a plurality of locations within working environment 200. Stated differently, local occupant data 144 may correspond to a number of occupants 10 transported by at least one of the plurality of elevator cars 210, 220 to at least one of the plurality of floors 204A-204D. Dispatch controller 130 may be configured to store the local occupant data 144 in memory 136 and associate the number of occupants 10 with a corresponding destination within working environment 200 (e.g., floors 204A-204D). For example, dispatch controller 130 may receive and correlate the motion data 140 received from motion controller 105 with the elevator occupant data 142 to determine the local occupant data 144.

Dispatch controller 130 may be further configured to periodically update the local occupant data 144 upon determining one or more elevator cars 210, 220 have traveled to and/or from one or more floors 204A-204D to transport at least one occupant 10. That is, dispatch controller 130 may continuously modify the local occupant data 144 to include a current count of occupants 10 at each floor 204A-204D based on determining a number of occupants 10 arriving to, or leaving from, each floor 204A-204D (e.g., as detected by counter device 125 in each elevator car 210, 220).

Further, memory 136 may include a non-transitory computer readable medium that stores machine-readable instructions thereon, such as, zoning logic 140. In one example, zoning logic 140 may include executable instructions that allow dispatch system 100 to determine when one or more of the plurality of elevator cars 210, 220 is in an inactive state and which location (e.g., a first location) to park elevator cars at while in the inactive state. The executable instructions of zoning logic 140 may further allow dispatch system 100 to determine a real-time occupant count (e.g., local occupant data 144) of a plurality of locations (e.g., floors 204A-204D) to identify a first location having a greater total occupant count than an occupant count of the remaining plurality of locations.

Dispatch logic 140 may further facilitate determining an occupant capacity of each elevator car 210, 220 based on a number of occupants 10 physically present within each elevator car 210, 220 (e.g., elevator occupant data 142). As described in further detail herein, dispatch system 100 may be configured to determine whether the number of occupants 10 present within each elevator car 210, 220 exceeds an occupant capacity of the respective elevator car 210, 220. When the occupant capacity of at least one elevator car 210, 220 is exceeded, dispatch system 100 may render the elevator car inoperable to answer additional call requests from prospective occupants 20 seeking transportation. That is, dispatch system 100 disregards the elevator car from further consideration when determining which of the plurality of elevator cars 210, 220 to dispatch to a new call request(s) until the number of occupants 10 in the elevator car no longer exceeds its occupant capacity.

Referring now to FIG. 5, an example method 300 of using dispatch system 100 to determine an occupant count at a plurality of locations and to position inactive elevator cars at the location having a greater occupant count is depicted. It should be understood that the steps shown and described herein, and the sequence in which they are presented, are merely illustrative such that various embodiments may include additional and/or fewer steps without departing from a scope of this disclosure. Further, it should be appreciated that dispatch system 100 may perform example method 300 in conjunction with one or more other processes, such as an example method 400 described in further detail herein (see FIG. 6).

At step 302, dispatch system 100 may receive a call request at a location of a plurality of locations within working environment 200. The call request may be initiated in response to a prospective occupant 20 actuating call device 110 at the location (e.g., an arrival location), such as, for example, at first floor 204A. Call device 100 may transmit the call request to dispatch controller 130 via network 115 and the call request may include data indicative of the arrival location (e.g., first floor 204A) from which the call request originated from. The call request may further include data indicative of a destination location (e.g., second floor 204B) within working environment 200 to which the prospective occupant 20 seeks to travel to.

At step 304, dispatch controller 130 may retrieve motion data 140 of each elevator car 210, 220 from a corresponding motion controller 105 to determine various movement parameters of each elevator car 210, 220, such as, for example, a current location, a travel direction, a travel speed, etc., of each elevator car 210, 220. Dispatch controller 130 may further retrieve elevator occupant data 142 of each elevator car 210, 220 from a corresponding counter device 125 to determine a current number of occupants 10 within each elevator car 210, 220. Dispatch controller 130 may be configured to analyze the motion data 140 and the elevator occupant data 142 of the plurality of elevator cars 210, 220 to determine which elevator car 210, 220 to dispatch to the arrival location.

In the present example, first elevator car 210 may be determined as an optimal elevator car from the plurality of elevator cars 210, 220 to dispatch to first floor 204A (e.g., the arrival location). In some embodiments, dispatch controller 130 may be configured to communicate with call device 110 to transmit a message to the prospective occupant 20 at the arrival location. For example, dispatch controller 130 may communicate an identification of the first elevator car 210 assigned to answer the call request. In other embodiments, dispatch controller 130 may identify first elevator shaft 202 from which first elevator car 210 may arrive from. The message may be transmitted via call device 110 in various suitable formats, including, for example, via a display (e.g., a written form, a graphic form, etc.), a speaker (e.g., an audible form), and more. As described in further detail herein, dispatch controller 130 may be inhibited from dispatching one or more elevator cars 210, 220 to the call request when an occupant capacity of the elevator car 210, 220 is exceeded (see FIG. 6).

At steps 306 to 310, dispatch controller 130 may be configured to determine an occupant count of a plurality of locations. For example, at step 306, dispatch controller 130 may be configured to determine a number of occupants 10 entering first elevator car 210 by retrieving elevator occupant data 142 from counter device 125 when answering the call request. Dispatch controller 130 may retrieve the elevator occupant data 142 in response to first elevator car 210 arriving at first floor 204A (e.g., the arrival location) and receiving one or more occupants 10 therefrom. Counter device 125 may transmit a signal to dispatch controller 130 via network 115 indicative of the elevator occupant data 142 of first elevator car 210.

In some embodiments, to determine the number of occupants 10 received from the arrival location, dispatch controller 130 may compare the number of occupants 10 within first elevator car 210 prior to arriving at first floor 204A to the number of occupants 10 located in first elevator car 210 after departing from first floor 204A. Stated differently, dispatch controller 130 may compute a difference between the number of occupants in first elevator car 210 before answering the call request (from first floor 204A) and the number of occupants in first elevator car 210 before completing the call request to second floor 204B. In the present example, first elevator 210 may include zero occupants 10 prior to answering the call request at the arrival location, and one occupant 10 upon departing from the arrival location to the destination location (e.g., second floor 204B). Accordingly, dispatch controller 130 may be configured to determine that one occupant 10 entered first elevator car 210 from first floor 204A.

Still referring to FIG. 5, at step 308, dispatch controller 130 may be configured to determine a number of occupants 10 exiting first elevator car 210 by retrieving elevator occupant data 142 from counter device 125 after completing the call. Dispatch controller 130 may retrieve the elevator occupant data 142 in response to first elevator car 210 arriving at second floor 204B (e.g., the destination location) and dropping off one or more occupants 10 thereto. For example, counter device 125 may be configured to detect an updated number of occupants 10 remaining within first elevator car 210 upon arriving at the destination location. Counter device 125 may transmit a signal to dispatch controller 130 via network 115 indicative of the elevator occupant data 142 of first elevator car 210.

In some embodiments, dispatch controller 130 may compare the updated number of occupants 10 remaining in first elevator car 210 (e.g., after departing from the destination location) to the number of occupants 10 within first elevator car 210 prior to arriving at the destination location (e.g., the elevator occupant data at step 306). In the present example, first elevator 210 may include one occupant 10 prior to completing the call request to the destination location, and zero occupants 10 upon departing from the destination location. Accordingly, dispatch controller 130 may determine that one occupant 10 exited first elevator car 210 at second floor 204B. It should be appreciated that counter device 125 may be configured to detect a total number of occupants 10 and/or objects 12 within first elevator car 210 (see FIG. 3) at steps 306 and 308. Thus, dispatch controller 130 may consider one or more objects 12 detected by counter device 125 when determining the number of occupants 10 in first elevator car 210.

Still referring to FIG. 5, at step 310, to determine an occupant count at the arrival and destination locations, dispatch controller 130 may be configured to incorporate the elevator occupant data 142 received from first elevator car 210 to the local occupant data 144 stored in memory 136. For example, memory 136 may include local occupant data 144 for each of the plurality of floors 204A-204D, which may be indicative of a current occupant count at each respective floor 204A-204D. Dispatch controller 130 may update the current occupant count of one or more locations based on the number of occupants 10 having entered first elevator car 210 from the arrival location (e.g., first floor 204A) and the number of occupants 10 having exited first elevator car 210 at the destination location (e.g., second floor 204B).

In the present example, dispatch controller 130 may modify the current occupant count (e.g., local occupant data 144) corresponding to first floor 204A by one occupant 10, i.e., the number of occupants 10 received by first elevator car 210 from the arrival location. In this instance, the current occupant count of first floor 204A, as stored on memory 136 in the form of local occupant data 144, may be decreased by one. Dispatch controller 130 may further modify the current occupant count corresponding to second floor 204B by one occupant 10, i.e., the number of occupants 10 transported by first elevator car 210 to the destination location. In this instance, the current occupant count of second floor 204B, as stored on memory 136 in the form of local occupant data 144, may be increased by one. It should be appreciated that dispatch controller 130 may be configured to continuously update the local occupant data 144 for each of the plurality of floors 204A-204D when at least one of the plurality of elevator cars 210, 220 transfers occupants 10 from an arrival location to a destination location.

Still referring to FIG. 5, at step 312, dispatch controller 130 may be configured to determine an operating status of first elevator car 210. For example, dispatch controller 130 may determine that first elevator car 210 is assigned to answer an additional call request. In this instance, first elevator car 210 may have an active state and dispatch controller 130 may be configured to dispatch first elevator car 210 to the arrival location of the additional call request at step 304. Alternatively, dispatch controller 130 may determine that first elevator car 210 includes an additional destination location to travel to based on an existing call of occupants 10 located within first elevator car 210. In this instance, first elevator car 210 may have an active state and dispatch controller 130 may be configured to dispatch first elevator car 210 to the destination location at step 304. Dispatch controller 130 may determine that first elevator car 210 is in an inactive state when no further call requests are assigned to first elevator car 210 and/or first elevator car 210 does not include any additional destination locations from existing calls.

In response to determining first elevator car 210 is in an inactive state at step 312, dispatch controller 130 may be configured to determine a first location from a plurality of locations that includes a maximum occupant count at step 314. That is, dispatch controller 130 may be configured to compare the local occupant data 144 of a plurality of locations relative to one another to assess a current occupant count at each location. Dispatch controller 130 may determine the first location includes a maximum occupant count that is greater than the occupant count of the remaining plurality of locations. In the present example, as seen in FIG. 2, first floor 204A may include zero occupants 20, second floor 204B may include one occupant 20 (e.g., recently transported thereto by first elevator car 210), third floor 204C may include two occupants 20, and fourth floor 204D may include three occupants 20. Accordingly, dispatch controller 130 may determine that fourth floor 204D includes a current occupant count that is greater than the current occupant count of the remaining floors 204A-204C.

Still referring to FIG. 5, at step 316, dispatch controller 130 may determine whether a number of other inactive elevator cars 220 positioned at the first location exceeds a predetermined threshold. For example, the predetermined threshold may be stored in memory 136 and selectively adjustable by an operator of dispatch system 100. In some embodiments, the predetermined threshold may include at least one elevator car. In other embodiments, the predetermined threshold may be a percentage of the plurality of elevator cars 210, 220 included in working environment 200. In response to determining the number of inactive elevator cars 220 positioned at the first location does not exceed the predetermined threshold at step 316, dispatch controller 130 may be configured to move first elevator car 210 to the first location at step 318.

In the present example, the predetermined threshold may include two elevator cars and dispatch controller 130 may identify one elevator car (e.g., second elevator car 220) located at the first location. Accordingly, dispatch controller 130 may be configured to dispatch first elevator car 210 to fourth floor 204D. First elevator car 210 may be positioned at fourth floor 204D while first elevator car 210 remains in an inactive state. Stated differently, first elevator car 210 may be parked at fourth floor 204D until a call request from one of the plurality of floors 204A-204D (e.g., via call device 110) is assigned to first elevator car 210 by dispatch controller 130. It should be appreciated that, with first elevator car 210 maintained at fourth floor 204D and with fourth floor 204D including a greater occupant count than the remaining plurality of floors 204A-204C, a minimum travel distance for answering a future call request with first elevator car 210 may be minimized.

Alternatively, in response to determining the number of inactive elevator cars 220 positioned at the first location exceeds the predetermined threshold at step 316, dispatch controller 130 may be configured to determine a second location from the plurality of locations that includes a maximum occupant count that is less than that of the first location. For example, at step 320, dispatch controller 130 may be configured to compare the local occupant data 144 of the plurality of locations relative to one another to determine the second location includes a maximum occupant count that is greater than the occupant count of the remaining plurality of locations but for the first location. In the present example, first floor 204A includes zero occupants 20, second floor 204B includes one occupant 20, third floor 204C includes two occupants 20, and fourth floor 204D includes three occupants 20 (see FIG. 2). Accordingly, dispatch controller 130 may determine fourth floor 204D includes the greatest occupant count and third floor 204C includes the second-greatest occupant count relative to the occupant count of the remaining floors 204A-204B.

In the present example, the predetermined threshold may include one elevator car and dispatch controller 130 may identify one elevator car (e.g., second elevator car 220) located at the first location. Accordingly, dispatch controller 130 may be configured to dispatch first elevator car 210 to third floor 204C at step 322. First elevator car 210 may be positioned at third floor 204C while first elevator car 210 remains in an inactive state. Stated differently, first elevator car 210 may be parked at third floor 204C until a call request from one of the plurality of floors 204A-204D is assigned to first elevator car 210 by dispatch controller 130. It should be appreciated that, with first elevator car 210 positioned at third floor 204D and second elevator car 220 positioned at fourth floor 204D, and with floors 204C-204D including the greatest occupant counts relative to the remaining plurality of floors 204A-204B, a minimum travel distance for answering a future call request with either elevator cars 210, 220 may be minimized.

It should be appreciated that dispatch controller 130 may be configured to periodically reassess the current occupant count (e.g., local occupant data 144) of each of the plurality of floors 204A-204D. Accordingly, dispatch controller 130 may move one or more inactive elevator cars 210, 220 to a modified first location and/or second location based on updated local occupant data 144. For example, in response to determining the first location (identified at step 314) no longer includes a greater occupant count relative to the plurality of other locations, dispatch controller 130 may be configured to reposition the inactive elevator car(s) 210, 220 to a modified first location having the greatest occupant count. Dispatch controller 130 may further determine that the second location (identified at step 320) no longer includes the second greatest occupant count relative to the plurality of other locations, such that the inactive elevator cars at the second location are repositioned to a modified second location having the second greatest occupant.

In some embodiments, method 300 may include further steps for positioning one or more inactive elevators at additional locations (e.g., a third location, etc.) when a number of inactive elevator cars at the second location exceeds a predetermined threshold. In other embodiments, the predetermined threshold may be omitted entirely such that any inactive elevator car 210, 220 is positioned at the first location. In further embodiments, the predetermined threshold may be automatically adjusted by dispatch controller 130 based on a traffic flow pattern of working environment 200. For example, dispatch controller 130 may be configured to build a model based on the motion data 140, the elevator occupant data 142, the local occupant data 144, and more, to map one or more traffic flow patterns. The data may be compiled over a duration (e.g., one day, one week, one month, one year, etc.) and stored on memory 136 for building the model.

The predetermined threshold may be modified based on one or more traffic flow patterns determined from the model. For example, dispatch controller 130 may be configured to increase and/or decrease the predetermined threshold at predefined intervals during a particular time period (e.g., a day, a week, a month, a year, etc.). In this instance, dispatch controller 130 may periodically adjust the predetermined threshold accordingly to promote traffic flow within working environment 200 via the plurality of elevator cars 210, 220. Further, dispatch controller 130 may be configured to determine the first location and/or the second location at least partially based on the traffic flow patterns of the model. For example, dispatch controller 130 may identify one or more floors 204A-204D having a greater occupant count relative to the remaining floors at predefined intervals during a particular time period (e.g., a day, a week, a month, a year, etc.). In this instance, dispatch controller 130 may periodically adjust a determination of the first location and/or the second location to promote traffic flow within working environment 200 via the plurality of elevator cars 210, 220.

Referring now to FIG. 6, an example method 400 of using dispatch system 100 to render an elevator car inoperable for receiving additional call requests when exceeding its occupant capacity is depicted. It should be understood that the steps shown and described herein, and the sequence in which they are presented, are merely illustrative such that additional and/or fewer steps may be included in various arrangements without departing from a scope of this disclosure. Further, it should be appreciated that dispatch system 100 may perform example method 400 in conjunction with one or more other processes, such as example method 300 described above.

At step 402, dispatch system 100 may receive a call request at a location of a plurality of locations within working environment 200. The call request may be initiated in response to a prospective occupant 20 actuating call device 110 at the location (e.g., one of floors 204A-204D). Call device 100 may transmit the call request to dispatch controller 130 via network 115. At step 404, dispatch controller 130 may retrieve elevator occupant data 142 of each elevator car 210, 220 from a corresponding counter device 125 to determine a current number of occupants 10 within each elevator car 210, 220. Counter device 125 may transmit a signal to dispatch controller 130 via network 115 indicative of the elevator occupant data 142 of the corresponding elevator car 210, 220.

Still referring to FIG. 6, at step 406, dispatch controller 130 may be configured to analyze the elevator occupant data 142 of the plurality of elevator cars 210, 220 to determine whether the number of occupants 10 exceeds a predefined elevator capacity of the respective elevator car 210, 220. It should be appreciated that each of the plurality of elevator cars 210, 220 may include a predefined occupant capacity that may vary relative to one another. The predefined occupant capacity may be stored on dispatch system 100, such as, for example, in memory 136. In some embodiments, the predefined occupant capacity may be selectively modified by an operator of dispatch system 100.

In other embodiments, dispatch controller 130 may be configured to automatically adjust the predefined occupant capacity of each of the plurality of elevator cars 210, 220 based on one or more parameters, such as the motion data 140, the elevator occupant data 142, the local occupant data 144, and more. As described in detail above, dispatch controller 130 may be configured to build a model based on the data such that dispatch controller 130 may adjust the predefined occupant capacity of elevators 210, 220 based on one or more traffic flow patterns determined from the model.

Still referring to FIG. 6, in response to determining the number of occupants 10 in the elevator car (e.g., first elevator car 210, second elevator car 220, etc.) does not exceed the predetermined occupant capacity at step 406, dispatch controller 130 may be configured to render the elevator car operable for receiving the call request at step 408. That is, dispatch controller 130 may determine the elevator car has an available status for consideration when determining which of the plurality of elevator cars 210, 220 to dispatch to the call request. In response to determining the number of occupants 10 in the elevator car exceeds the predetermined occupant capacity at step 406, dispatch controller 130 may be configured to render the elevator car inoperable for receiving the call request at step 410. In this instance, dispatch controller 130 may determine the elevator car has an unavailable status such that the elevator car is omitted from consideration when determining which of the plurality of elevator cars 210, 220 to dispatch to the call request.

At step 412, dispatch controller 130 may be configured to wait a predetermined duration (e.g., one second, one minute, etc.) prior to returning to step 404 to reassess the number of occupants 10 within the elevator car (e.g., via counter device 125). In this instance, dispatch controller 130 may be configured to update the operating status of the elevator car (e.g., available, unavailable, operable, inoperable, etc.) upon determining the updated number of occupants 10 no longer exceeds the occupant capacity of the elevator car. Alternatively, counter device 125 may be configured to transmit a signal to dispatch controller 130 via network 115 indicative of the updated occupant count within the corresponding elevator car 210, 220. In this instance, receipt of the signal from counter device 125 may provide a reassessment of the operating status of the elevator car 210, 220 by dispatch controller 130. In other embodiments, dispatch controller 130 may omit step 412 from example method 400 such that the elevator car may be disregarded entirely for the particular call request received at step 402.

It should be appreciated that the one or more processes of dispatch system 100 shown and described herein, such as example methods 300, 400, may be implemented in various other working environments. In one example, dispatch system 100 may be configured to apply one or more of example methods 300, 400 in a transit system, such as a bus service, a train service, a subway service, a metro service, a ridesharing service, etc. With respect to example method 300, dispatch system 100 may determine an occupant count at a plurality of locations (e.g., bus stops, train stops, subway stops, metro stops, etc.) to position inactive transportation unit (e.g., a bus, a train, a subway, a metro, a vehicle, etc.) at the location having a greater occupant count.

With respect to example method 400, dispatch system 100 may render a transportation unit (e.g., a bus, a train, a subway, a metro, a vehicle, etc.) inoperable for receiving additional call requests and/or occupants when exceeding its occupant capacity. In this instance, the transportation unit may bypass the location (e.g., the stop) and/or inhibit receipt of occupants onto the transportation unit (e.g., by not opening doors). In some embodiments, dispatch system 100 may be configured to communicate with one or more remote stations to transmit information indicative of the occupant data. For example, dispatch system 100 may transmit alerts to the remote station(s) requesting assistance from additional transportation units (e.g., a bus, a train, a subway, a metro, a vehicle, etc.) at one or more locations when the occupant capacity of one or more current transportation units are exceeded. It should be appreciated that dispatch system 100 may promote traffic flow by determining a minimum number of transportation units required at one or more locations, or at one or more predefined intervals, to accommodate a number of expected occupants based on prior occupant data.

All technical and scientific terms used herein have the same meaning as commonly understood to one of ordinary skill in the art to which this disclosure belongs unless clearly indicated otherwise. As used herein, the singular forms “a”, “an”, and “the” include plural references unless the context clearly dictates otherwise.

The above description is illustrative and is not intended to be restrictive. One of ordinary skill in the art may make numerous modifications and/or changes without departing from the general scope of the disclosure. For example, and as has been described, the above-described embodiments (and/or aspects thereof) may be used in combination with each other. Additionally, portions of the above-described embodiments may be removed without departing from the scope of the disclosure. In addition, modifications may be made to adapt a particular situation or material to the teachings of the various embodiments without departing from their scope. Many other embodiments will also be apparent to those of skill in the art upon reviewing the above description.

What is claimed is:

1. A method for positioning a plurality of elevator cars, the method comprising:
determining an occupant count for each of a plurality of locations by:
determining the number of occupants exiting the plurality of elevator cars at each of the plurality of locations; and
determining the number of occupants entering the plurality of elevator cars from each of the plurality of locations; and
moving at least one of the plurality of elevator cars to a first location with a total occupant count that is greater than the occupant count at each respective location of the plurality of locations when the at least one of the plurality of elevator cars is in an inactive state.

2. The method of claim 1, further comprising:
parking the at least one of the plurality of elevator cars at the first location when the at least one of the plurality of elevator cars is in the inactive state.

3. The method of claim 1, further comprising:
determining a number of occupants in the plurality of elevator cars when each of the plurality of elevator cars is in an active state.

4. The method of claim 1, further comprising:
determining a destination of the plurality of elevator cars from the plurality of locations.

5. The method of claim 4, further comprising:
updating the occupant count for each of the plurality of locations in response to determining one or more of the plurality of elevator cars is in the active state and have the destination of at least one of the plurality of locations.

6. The method of claim 1, further comprising:
determining the occupant count for each of the plurality of locations by computing a difference of:
the number of occupants exiting the plurality of elevator cars at each of the plurality of locations; and
the number of occupants entering the plurality of elevator cars from each of the plurality of locations.

7. The method of claim 1, wherein each of the plurality of elevator cars includes a counter device configured to generate data indicative of the number of occupants in the respective elevator car of the plurality of elevator cars.

8. The method of claim 1, further comprising:
moving at least a subset of the plurality of elevator cars in the inactive state to a second location having a second total occupant count that is greater than the occupant count at each respective location of the plurality of locations.

9. The method of claim 8, wherein the second total occupant count of the second location is less than the total occupant count of the first location such that the plurality of elevator cars in the inactive state are configured to prioritize the first location over the second location.

10. The method of claim 9, further comprising:
determining a number of elevator cars of the plurality of elevator cars in the inactive state at the first location exceeds a threshold; and
moving the subset of the plurality of elevator cars in the inactive state to the second location.

11. The method of claim 1, further comprising:
determining the number of occupants in a first elevator car exceeds an occupant capacity of the first elevator car; and
rendering the first elevator car inoperable for receiving a call such that the first elevator car is disregarded from the call.

12. The method of claim 10, further comprising:
determining the number of occupants in a first elevator car is below an occupant capacity of the first elevator car; and
rendering the first elevator car operable for receiving the call.

13. The method of claim 11, wherein the first elevator car includes a counter device configured to count the number of occupants in the first elevator car.

14. A system for positioning a plurality of elevator cars, comprising:
at least one counter device positioned in each of the plurality of elevator cars, the at least one counter device is configured to generate data indicative of a number of occupants in the plurality of elevator cars; and
a dispatch controller operably coupled to the at least one counter device in each of the plurality of elevator cars such that the dispatch controller receives data indicative of the number of occupants in the plurality of elevator cars;
wherein the dispatch controller is configured to determine an occupant count for each of a plurality of locations by:
determining the number of occupants exiting the plurality of elevator cars at each of the plurality of locations; and
determining the number of occupants entering the plurality of elevator cars from each of the plurality of locations; and
wherein the dispatch controller is configured to move at least one of the plurality of elevator cars to a first location with a total occupant count that is greater than the occupant count at each respective location of the plurality of locations when the at least one of the plurality of elevator cars is in an inactive state.

15. The system of claim 14, wherein the dispatch controller is configured to park the at least one of the plurality of elevator cars at the first location when the at least one of the plurality of elevator cars is in the inactive state.

16. The system of claim 14, wherein the dispatch controller is configured to determine:
a number of occupants in the plurality of elevator cars when each of the plurality of elevator cars is in an active state; and
a destination of the plurality of elevator cars from the plurality of locations.

17. The system of claim 16, wherein the dispatch controller is configured to update the occupant count for each of the plurality of locations in response to determining one or more of the plurality of elevator cars is in the active state and have the destination of at least one of the plurality of locations.

18. The system of claim 14, wherein the dispatch controller is configured to determine the occupant count for each of the plurality of locations by computing a difference of:
the number of occupants exiting the plurality of elevator cars at each of the plurality of locations; and
the number of occupants entering the plurality of elevator cars from each of the plurality of locations.

19. The system of claim 14, wherein the dispatch controller is configured to determine the number of occupants in a first elevator car:
exceeds an occupant capacity of the first elevator car and render the first elevator car inoperable for receiving a call such that the first elevator car is disregarded from the call; or
is below an occupant capacity of the first elevator car and render the first elevator car operable for receiving the call.

20. A system for controlling traffic flow of a plurality of elevator cars, comprising:
a processor; and
a memory storing instructions that, when executed by the processor, causes the processor to perform operations including:
determining an occupant count for each of a plurality of locations by:
determining the number of occupants exiting the plurality of elevator cars at each of the plurality of locations; and
determining the number of occupants entering the plurality of elevator cars from each of the plurality of locations; and
moving at least one of the plurality of elevator cars to a first location with a total occupant count that is greater than the occupant count at each respective location of the plurality of locations when the at least one of the plurality of elevator cars is in an inactive state.
